(19) United States
(12) Patent Application Publication
(10) Pub. No.: US 2009/0055694 A1
(43) Pub. Date: Feb. 26, 2009

(54) APPARATUS AND METHOD FOR MEASURING SKEW IN SERIAL DATA COMMUNICATION

(75) Inventors: P. E. RAMESH, Bangalore (IN); Tetsuo OBATA, Mishima-city (JP)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/190,404

(22) Filed: Aug. 12, 2008

(30) Foreign Application Priority Data
Aug. 22, 2007 (IN) 1606/MUM/2007

(51) Int. Cl. G06F 11/00

(52) U.S. Cl. 714/700; 714/E11.001

(57) ABSTRACT

An apparatus and method measures the skew between signals on data and clock channels using a bit pattern matching technique for any given protocol in Serial data communication. In one embodiment, the method of finding the pattern comprises of importing the waveform data from the oscilloscope and converting the waveform into bit patterns, finding the pattern index on the converted bit stream using a pattern based on the TMDS channel combination, and then measuring the skew.

### CLAIM FOR PRIORITY

The subject application claims priority under 35 U.S.C. 119 from Indian provisional patent application 1606/MUM/2007 (Ramesh, et al), filed 22 Aug. 2007, entitled, A METHOD AND SYSTEM TO MEASURE THE SKEW BETWEEN THE SIGNALS ON THE DATA AND CLOCK CHANNEL USING THE BIT PATTERN MATCHING TECHNIQUE FOR ANY GIVEN PROTOCOL IN SERIAL DATA COMMUNICATION, and from Indian regular patent application 1606/MUM/2007 (Ramesh, et al.), filed 5 Aug. 2008, also entitled, A METHOD AND SYSTEM TO MEASURE THE SKEW BETWEEN THE SIGNALS ON THE DATA AND CLOCK CHANNEL USING THE BIT PATTERN MATCHING TECHNIQUE FOR ANY GIVEN PROTOCOL IN SERIAL DATA COMMUNICATION.

### FIELD OF THE INVENTION

The present invention relates generally to serial data communication and more particularly to measurement of skew between signals.

### BACKGROUND OF THE INVENTION

For more than a decade now, Video Graphics Array (VGA)/Super Video Graphics Array (SVGA) display technique has been in wide use. VGA utilizes the analog transmission technique as it is driven by PC graphics card that converts the Graphics images into three analog signals representing the RGB pattern for the pixel information.

In addition to the video signal, these signals also send the horizontally synchronizing (Hsync) and vertically synchronizing (Vsync) signal that are generally used to identify the beginning of new line and new frame.

With increase in resolution over the years due to advancements in digital technology, VGA resolution has been left behind. For example, the Microsoft Windows splash screen appears while the machine is still operating in VGA mode, which is the reason that this screen always appears in reduced resolution and color depth.

VGA being analog technology has never had encryption to prevent pirating or copying of high definition sources. Further, VGA was unable to address the monitor's picture elements—the individual pixels—precisely. It consumed more power and made the devices slower.

All these factors have resulted in VGA technology being replaced with Digital transmission technique using DVI (Digital video interface) in recent years.

As against the VGA technology the DVI uses a digital protocol in which the desired illumination of pixels is transmitted as binary data. With development in digital audio transmission techniques it has lead to another technology similar to DVI but with addition of Audio (up to 8-channels uncompressed) and having Smaller Connector came to be known as HDMI (High Definition Multimedia interface).

In contrast to VGA, which only supports up to 720p, the HDMI supports 720p, 1080i and 1080p. HDMI also provides a superior picture over VGA or Component Video as the synchronization between channels is better.

HDMI was the new source incorporated to replace component cables. Component cables while they do transmit high definition is again an analog source and has many cables, red/blue/green video red/white audio cables.

HDMI carries video, audio, and auxiliary data via one of three modes called the Video Data Period, the Data Island Period, and the Control Period. During the Video Data Period, the pixels of an active video line are transmitted. During the Data Island period (which occurs during the horizontal and vertical blanking intervals), audio and auxiliary data are transmitted within a series of packets. The Control Period occurs between Video and Data Island periods.

Also, HDMI provides one cable that transmits audio and video and has up scaling capabilities all while maintaining a pure digital source where as component required five cables. HDMI/DVI consist of three data channels (D0, D1, D2) and an explicit clock channel. The data sent by channel 2 is RED, channel 1 sends GREEN and data channel 0 sends BLUE Signal. The clock is sent on an explicit separate channel.

Apart from video information, blue channel also carries the control signal Hsync, Vsync during the blanking interval. The audio signal is also inserted in digital format and transmitted during the control period.

Analog transmission technology is more sensitive to the phase changes and it is also extremely susceptible to interference. This causes attenuation of the signal due to impairments as the waves of external signals can interact with a specific signal, altering its shape leading to larger skew problems and makes the measurement difficult.

For example, Temperature variations and component aging introduce slowly varying delays which drift over time. This has lead to digital transmission Skew measurement technology.

Typically, methods known in the art for correcting the skew rely on a trial and error approach. An originally matched set of symbols from a transmitter is received on different lines, and different delays are inserted into each of the lines until the received symbols match. However, using this method consumes considerable time before the skew is determined.

Also, traditionally Skew is measured for analogue signals by applying the same signal to both the channels, for example, “From” and “TO” channels, then the time difference is calculated during rising or falling edge of the signals using an oscilloscope.

In HDMI Digital video transmission, the data channels are derived from three encoders and the signal on the data channel makes a transition from one digital logic state to another depending upon the Decoded pattern information using the TMDS (Transition minimized Differential Signaling: a technology for transmitting high-speed serial data) decoding technique. The transitions on the channels are totally uncorrelated as this depends upon the pixel information, so we cannot use the transition on the “FROM” or “TO” channel as reference to measure the skew. Thus, the traditional method of measuring the Skew is rendered useless.

Known systems for measuring the skew Measuring Skew in Electronic Systems are found in Publication (W0/1989/001634) for channel-to-channel skew. This publication describes a method for measuring channel-to-channel skew or phase difference in an electronic system of the type having a plurality of input channels which are sampled by sampling pulses having a frequency f₀ and a period P₀. The sampling pulses at each input channel are first mixed with a reference signal having a frequency fr and a period Pr that differ from the frequency and period of the sampling pulses. The mixing produces a beat signal at each input channel. A quantity termed “effective measurement interval” which is equal to the difference of the periods of the sampling pulses, P₀, and the reference signal, Pr, is computed. A quantity termed “apparent skew” which is equal to the number of periods P₀ of the sampling pulses which represents the skew or phase difference between the beat signals is also determined. Finally, skew of phase difference of the sampling pulses is computed by multiplying the “effective measurement interval” by the “apparent skew”.

However the above method may not provide for measuring skew between clock channels and various other signals and protocols. There is therefore a requirement of a system and method for providing simple and reliable means of measuring skew.

### SUMMARY OF THE INVENTION

The subject invention is an apparatus and method to measure the skew between signals for various protocols in Serial data communication. In one embodiment, a signal is acquired from each of the channels between which the skew is desired to be measured. Conversion of the signals into bit patterns is then performed. The index of the bit patterns matching the reference bit pattern are identified and thereafter converted into record point to calculate the skew.

In a further embodiment of the method of measuring the skew, the signals are acquired from each of the said channels for finding the cross over points in an acquired signal from each of the combination of channels under test. In a further step the acquired signals are converted into bit patterns. In yet a further step, the bit pattern index of the converted bit patterns matching with a reference bit pattern, are identified. Finally such indexes are converted to a waveform and calculation of the time difference between said record points on different channels to derive the skew value then takes place.

Thus, the present apparatus and method provides a reliable method of measuring skew between channels carrying signals in a serial data communication.

### BRIEF DESCRIPTION OF THE DRAWING

Reference will be made to embodiments of the invention, examples of which may be illustrated in the accompanying FIGUREs. These FIGUREs are intended to be illustrative, not limiting. Although the invention is generally described in the context of these embodiments, it should be understood that it is not intended to limit the scope of the invention to these particular embodiments.

FIG. 1 shows a setup for measuring skew in accordance with the invention.

FIG. 2. shows the TMDS Link between the Source and Sink according to an embodiment herein.

FIG. 3. shows the Different periods of the digital video transmission according to an embodiment herein.

FIG. 4. shows the bit patterns in various TMDS channels of the TMDS link as per an embodiment herein.

FIG. 5. shows a Flow chart of the method for measuring the skew according to an embodiment herein.

FIG. 6 shows the TMDS waveforms according to an embodiment herein.

FIGS. 7a, 7b, 7c, and 7d show the Result validation of the Skew Measurement according to an embodiment herein.

### DETAILED DESCRIPTION OF THE DRAWING

An apparatus and method to measure the skew between the signals for various protocols in Serial data communication will now be described with reference to the FIGURES. In one embodiment, a signal is acquired from each of the channels between which the skew is desired to be measured. Conversion of the signals into bit pattern is then performed. The index of the bit patterns matching the reference bit pattern are identified and thereafter converted into record point to calculate the skew.

In the following description, for purposes of explanation, specific details are set forth in order to provide an understanding of the embodiments herein. It will be apparent, however, to one skilled in the art that the embodiments herein may be practiced without these details. One skilled in the art will recognize that the embodiments herein, some of which are described below, may be useful in numerous serial communication systems. Structures and devices described herein and provided in the accompanying block diagrams are illustrative of exemplary embodiments. Descriptions of well-known components and processing techniques are omitted so as to not unnecessarily obscure the embodiments herein. Furthermore, connections between components within the FIGURES are not intended to be limited to direct connections. Rather, data between these components may be modified, re-formatted, or otherwise changed by intermediary components.

Reference in the specification to “one embodiment” or “an embodiment” means that a particular feature, structure, characteristic, or function described in connection with the embodiment is included in at least one aspect of the embodiments herein. Furthermore, the appearances of the phrase “in one embodiment” in various places in the specification are not necessarily all referring to the same embodiment.

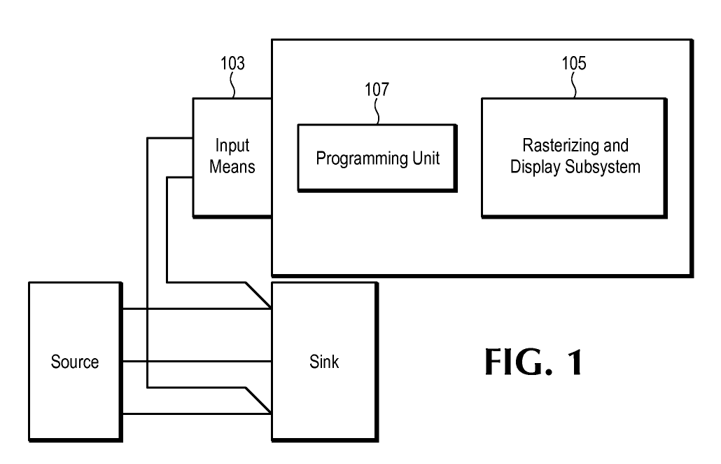

Referring to FIG. 1, there is shown a setup for measuring the skew using the system as per an embodiment herein. The setup comprises of the system (101) configured in a specialized DSO configured as per the teachings of this invention, having connected probes to the channels under test. In the exemplary setup shown the channel 0 and channel 2 are under test. Also the specialized DSO configured as per the teachings of this invention consists of an input means and programming unit. Further rasterizing and display subsystem are also provided.

The input means is configured to acquire signals from a combination of channels to be tested. Further a programming unit (107) configured to convert the acquired signal from each of the channel into bit patterns. Also, the programming unit is configured to identify the bit pattern matching with a reference bit pattern to identify the index of such identified bit patterns and calculate the skew between such indexes.

The video transmission signal consist of Vsync used for the Vertical frame synchronization during the vertical blanking interval, Hsync is for synchronizing the start of the new line during the Horizontal blanking and then each line caries the video data after the blanking interval. The duration of Blanking intervals depend upon the video resolution. More than two horizontal lines are acquired to ensure the co-coordinated bit stream is present on the acquire record. Oscilloscope setup may be done universally the same to accommodate for all resolutions. This ensures the probability occurrence of the pattern on the acquired record of about more than 90% (approximately) of the time and failure to find pattern will be less than 5% (approximately). The exemplary setup shown may be used for resolutions up to 1080P (2.25 Gbits/sec) and this can be extended for other data rates.

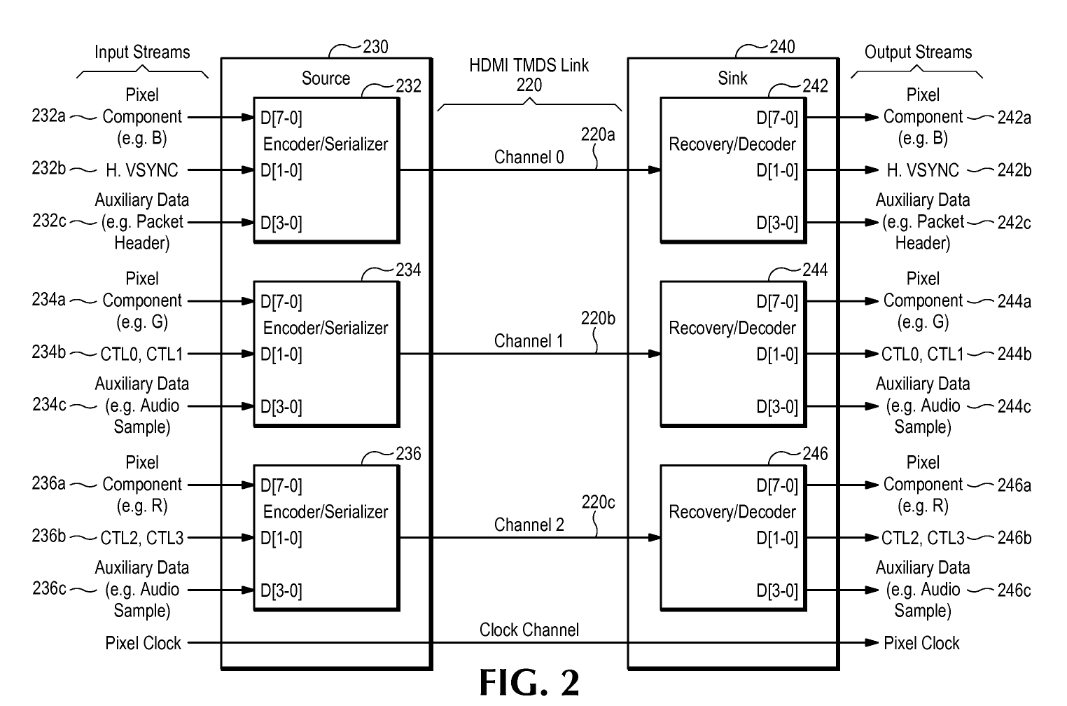

FIG. 2 shows, per an embodiment herein, the channels between various combinations of which skew needs to be measured. The HDMI TMDS link comprises of channel 0, channel 1, channel 2 and a pixel clock channel. Each of channel 0, channel 1, and channel 2 has encoders and decoders provided on each side of the link. Together the encoders near the input streams act as Source (230) and the decoders near the output streams as Sink (240). Encoder 0 (232) has three input lines comprising of pixel component (232a), Hsync and Vsync (232b), Auxiliary data (232c). Further the encoder 1 has three input lines comprising pixel component (234a), control lines (234b) and Auxiliary data line (234c). The encoder 2 has three input lines comprising of pixel component (236a), control line (236b) and Auxiliary data line (236c). Corresponding lines are found at the output streams of each of the decoders 242-246.

The TMDS Clock channel constantly runs at the pixel rate of the transmitted video. During every cycle of the TMDS Clock channel, each of the three TMDS data channels transmits a 10-bit character. This 10-bit word is encoded using one of several different coding techniques.

The input stream to the Source's encoding logic will contain video pixel, packet and control data.

The packet data consists of audio and auxiliary data and associated error correction codes.

These data items are processed in a variety of ways and are presented to the TMDS encoder as either 2 bits of control data, 4 bits of packet data or 8 bits of video data per TMDS channel. The Source encodes one of these data types or encodes a Guard Band character on any given clock cycle.

This invention will enable the measurement of Skew between TMDS channels such as Channel0-Channel1, Channel0-Channel2, Channel1-Channel2 channels. At any given instance the HDMI TMDS link may be at any one of the three periods, they are: Video Data period, Data Island Period, and Control period. During the video period, the active video pixel of an active Line is transmitted, During the data Island period audio and auxiliary data are transmitted; Control period is used when no video, audio, auxiliary information are transmitted. Control period is required between any two periods that are not control period.

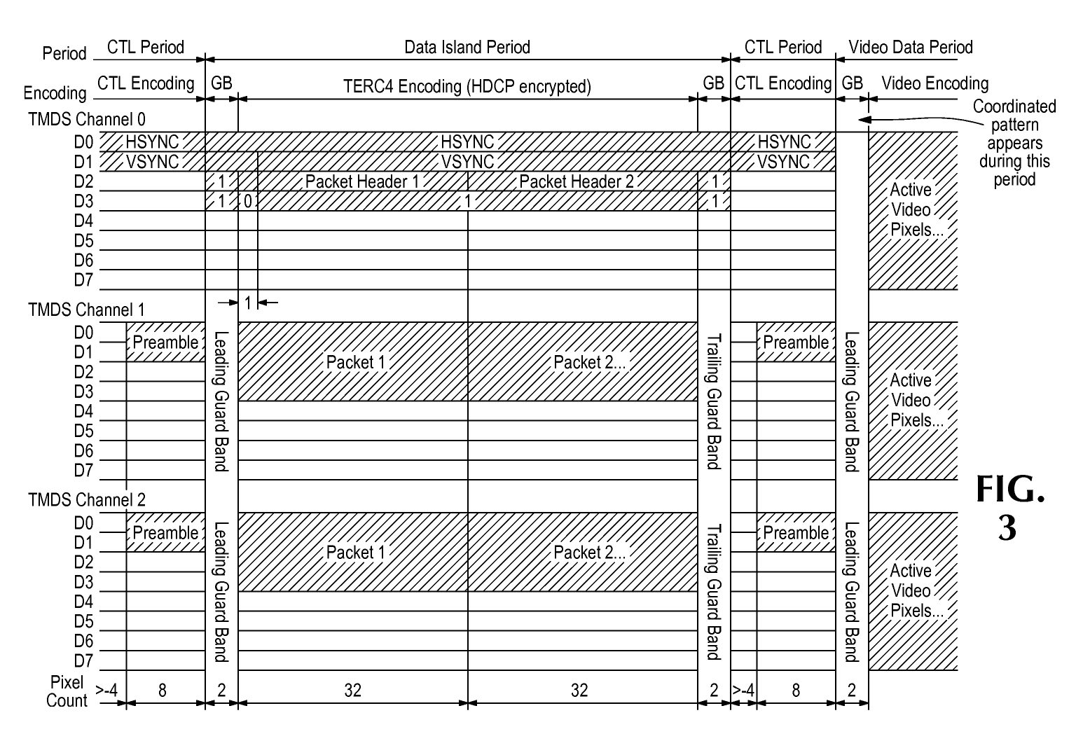

FIG. 3 shows, according to an embodiment herein, the different periods of the digital video transmission on various channels. It may be seen in the FIGURE that each video data period and Data island period are preceded with guard band to indicate the transition of the band from control period to data island period.

The TMDS channels put the data during the control period based on the Control signal bits input on the respective channel. The Data bits during the Leading video guard band combined with preamble occurs simultaneously on all the three channels.

The TMDS Channel1 carries the video information as well Synch information. The Hsync is followed according to the standard 861B video standard The Hsync can be positive polarity or negative polarity depends upon the resolution. The bit pattern on this channel prior to the video guard band depends upon the polarity. It has positive polarity or negative polarity depends upon the resolution. The bit pattern value depends upon the Hsync and V synch bits (0, 0) and (1, 1) and other combination. During the Video Guard band period, the TMDS pattern on the other TMDS channel 1 and 2 corresponds to the pattern mentioned in the standard specification of High Definition Multimedia Interface 1.2a

As may be seen in FIG. 3, prior to the video guard band is a control period periods (CTL period). Wherein the Hsync and Vsync is 0 for Positive Synch polarity. Therefore the Data 0 channel has the pattern (0, 0: q_out [9:0]=0b1101010100.

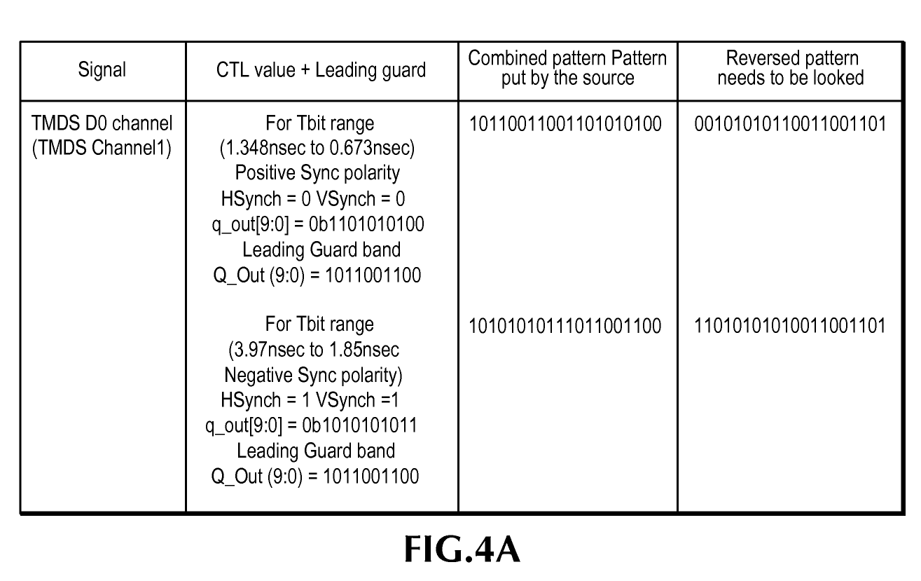

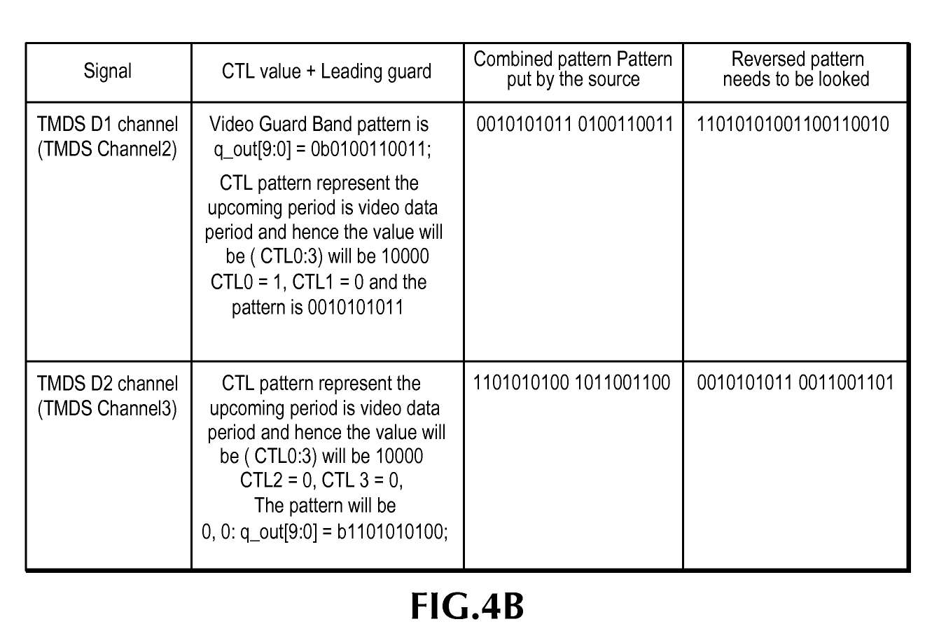

Further, by combining this pattern for the Data 0 channel with video guard band pattern for TMDS Channel1 we get reversed pattern as 00101010110011001101 20-bit pattern. Similarly by combining guard band with the pattern for other channel 1 and Channel 2 the results are as shown in FIG. 4.

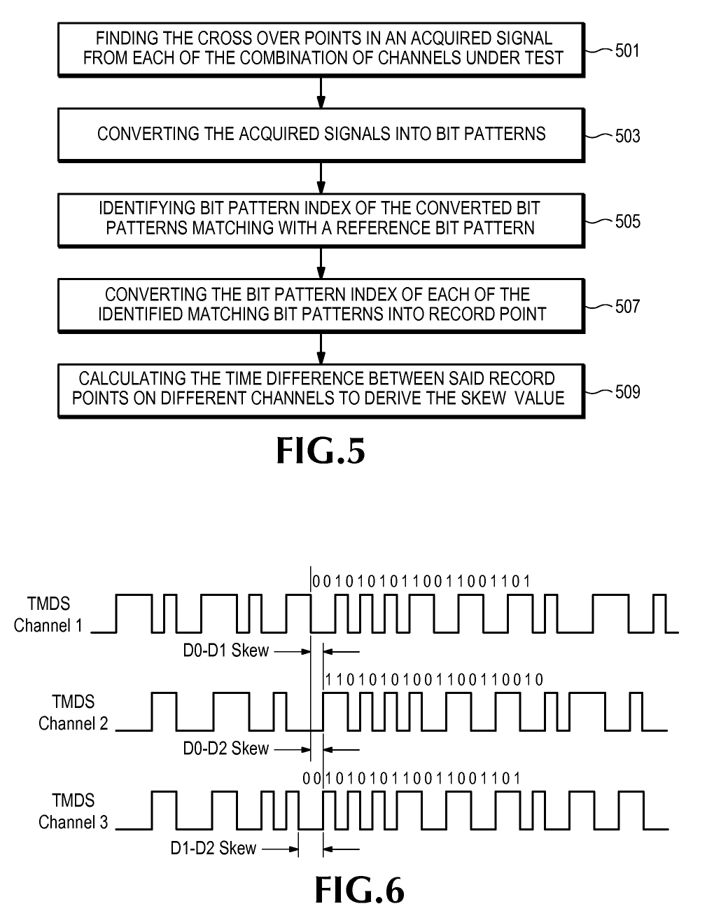

The method to measure the skew between the channels in Serial data communication is described with reference to flow chart in FIG. 5.

To execute the method of measuring the skew, a particular setup of the system is required. More particularly more than two horizontal lines are acquired to ensure the co-coordinated bit stream is present in the acquired record. Oscilloscope setup may be done universally the same to accommodate for all resolutions. This ensures the probability of occurrence of the pattern in the acquired record of about more than 90% (approximately) of the time, and failure to find pattern will be less than 5% (approximately). The exemplary setup shown may be used for resolutions up to 1080P (2.25 Gbits /sec) and this can be extended for other data rates.

The skew measurements of the selected channels are done by first connecting the probes of a specialized DSO, configured per the teachings of the subject invention, to the channels under test.

The signals are then acquired from each of the channels for finding the crossover points in an acquired signal from each of the combination of channels under test. A further step comprises converting the acquired signals into bit patterns.

A yet further step includes identifying a bit pattern index of the converted bit patterns matching with a reference bit pattern. For example as shown in FIG. 6 the bit pattern in TMDS channel 1 is 00101010110011001101, of which the index is identified. Further the bit pattern in TMDS channel 1 is 11010101001100110010, which is negative of the reference bit pattern, which also needs to be checked; the index of such bit pattern is also identified. The bit pattern in TMDS channel 2 is 00101010110011001101, the index of such bit pattern is identified.

To find out the time difference between such indexes of the identified matching bit patterns further processing is required. It is important to note that the matching bit patterns also include the negative of the reference bit pattern as it may be caused due to negative polarity caused due to resolution.

Therefore, the further steps include converting the bit pattern index of each of the identified matching bit patterns into record points. This method includes the steps of converting the bit pattern index of each of the identified matching bit patterns into waveform record and finding the time value of such indexed using the sample interval information.

Calculating the time difference between the record points on different channels to derive the skew value then takes place. More particularly, the indexes of the matching bit patterns are converted into waveform records and then to time values, using the sample interval information.

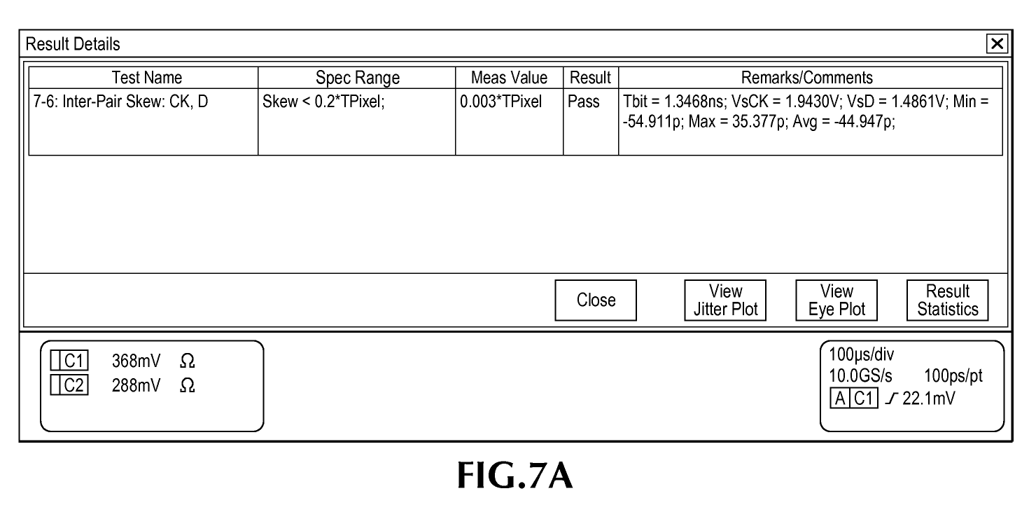

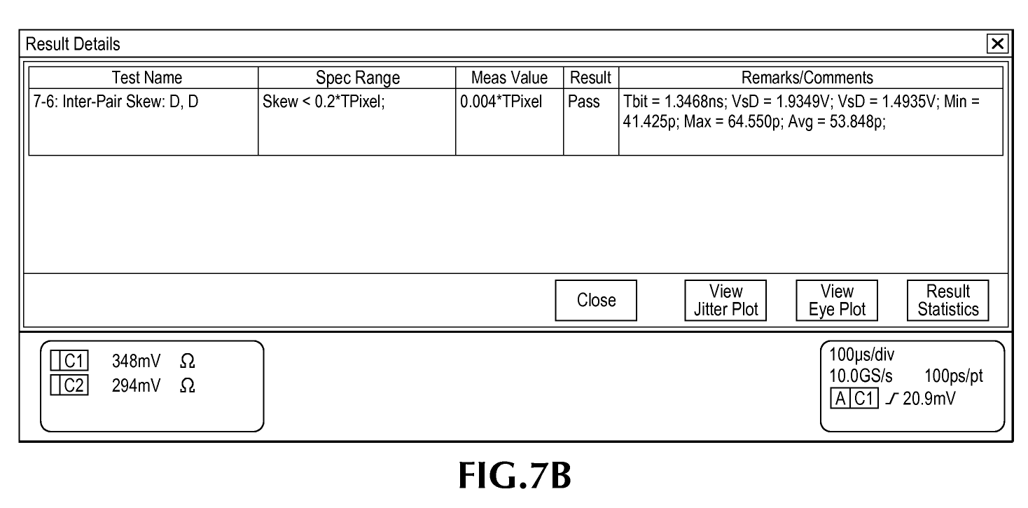

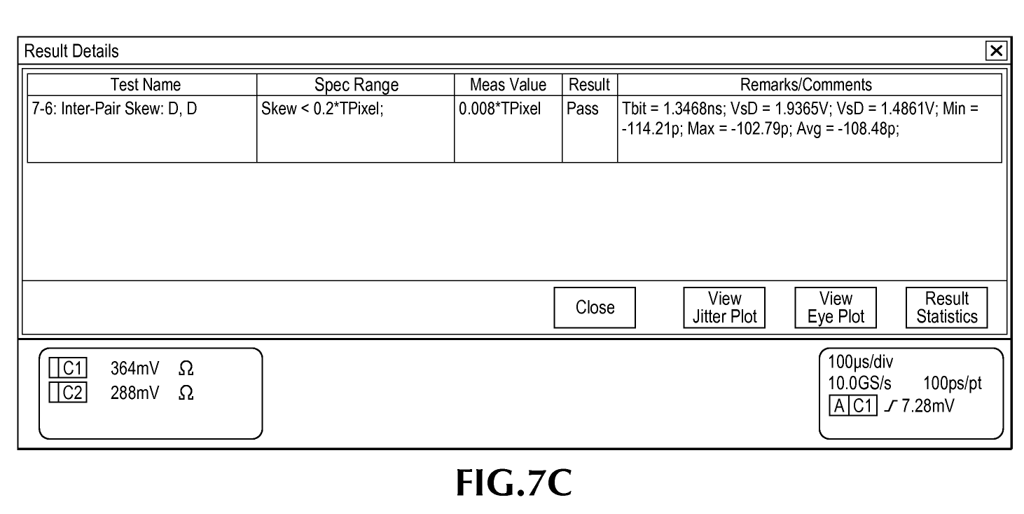

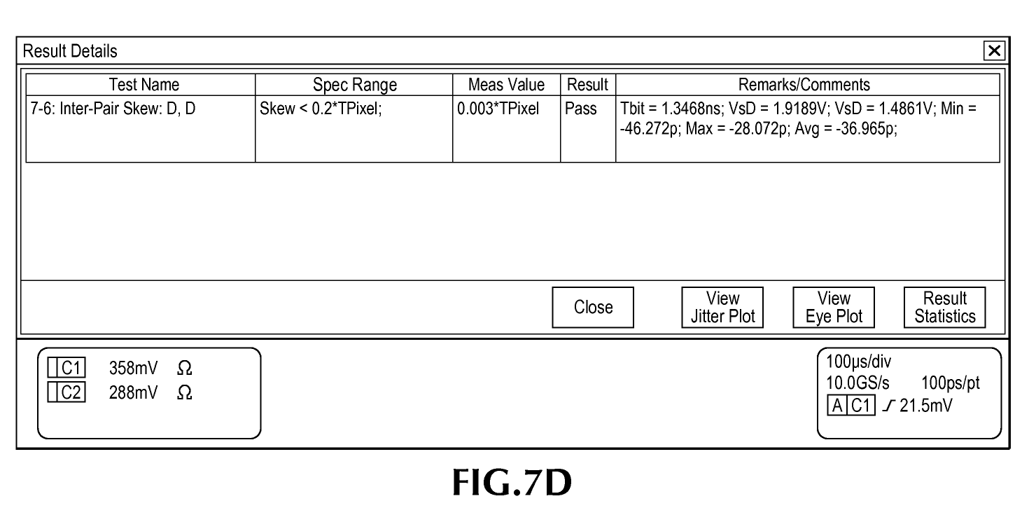

The clock data channel skew also can be measured by measuring the start of the pattern to the Clock transition edge. Result validations of the Skew Measurement are shown in FIG. 7. Specifically FIG. 7a shows the result validation of the skew measurement for the Clock Data Skew. Further, FIG. 7b shows the result validation of the skew measurement for the Data Skew D1-D2. FIG. 7c shows the result validation of the skew measurement for the Data Skew D0-D1. FIG. 7d. shows the result validation of the skew measurement for the Data Skew D0-D2.

The present system and method thus provides a simple and reliable method of measuring skew between channels carrying signals in a serial data communication.

While the present invention has been described with reference to certain exemplary embodiments, those skilled in the art will recognize that various modifications may be provided. Accordingly, the scope of the invention is to be limited only by the following claims.

We claim:

1. A method to measure skew between signals on channels in serial data communication comprising the step of:
finding the cross over points in an acquired signal from each of the combination of channels under test;
converting the acquired signals into bit patterns;
identifying bit pattern index of the converted bit patterns matching with a reference bit pattern;
converting the bit pattern index of each of the identified matching bit patterns into record point;
calculating the time difference between said record points on different channels to derive the skew value.

2. The method as in claim 1 wherein the acquisition of said acquired signal is done using probes on the combination of channels between which the skew needs to be measured.

3. The method as in claim 1, wherein the identification of the crossover in the acquired signal is done by finding the edge in the acquired signal.

4. The method as in claim 1, wherein each of the steps of:
finding the cross over points in an acquired signal from each of the combination of channels under test;
converting the acquired signals into bit patterns;
identifying bit pattern index of the converted bit patterns matching with a reference bit pattern; and
converting the bit pattern index of each of the identified matching bit patterns into record point;
takes place substantially simultaneously for each of the channels.

5. The method as in claim 1, wherein each of the steps of:
finding the cross over points in an acquired signal from each of the combination of channels under test;
converting the acquired signals into bit patterns;
identifying bit pattern index of the converted bit patterns matching with a reference bit pattern; and
converting the bit pattern index of each of the identified matching bit patterns into record point;
takes place consecutively for each of the channels.

6. The method as in claim 1, wherein the conversion of the index of the identified matching bit pattern into record further comprises the steps of:
converting the bit pattern index of each of the identified matching bit patterns into waveform record;
finding the time value of such index using the sample interval information.
The method as in claim 1, wherein the conversion of the acquired signals into bit patterns is performed using cross over edge Tbit interval technique.

7. A system for finding skew between channels in a serial data communication, the system comprising:
input means to acquire signals from a combination of channels to be tested;
a programming unit configured to convert the acquired signal from each of the channel into bit patterns;
said programming unit also configured to identify the bit pattern matching with a reference bit pattern to identify the index of such identified bit patterns and calculate the skew between such indexes.
